(19) United States
(12) Patent Application Publication
(10) Pub. No.: US 2013/0021307 A1
(43) Pub. Date: Jan. 24, 2013

(54) DISPLAY SYSTEM, DISPLAY APPARATUS, AND CONTROL METHOD

(71) Applicant: Yoshiharu YANAGI, Kawasaki (JP)

(72) Inventor: Yoshiharu YANAGI, Kawasaki (JP)

(73) Assignee: FUJITSU LIMITED, Kawasaki-shi (JP)

(21) Appl. No.: 13/547,614

(22) Filed: Jul. 12, 2012

(30) Foreign Application Priority Data
Jul. 19, 2011 (JP) 2011-158026

(51) Int. Cl. G09G 5/00

(52) U.S. Cl. 345/204

(57) ABSTRACT

An information processing apparatus switches a display state of an image to be output to a predetermined display state in the case where connection of another device is detected by receiving a connection signal and then the connection signal is not received again only for a predetermined time. An interface unit of a display apparatus receives image data produced from the information processing apparatus. A controller of the display apparatus allows the interface unit to repeatedly output the connection signal at a period shorter than the predetermined time, and allows the information processing apparatus to detect connection of the display apparatus in each case.

### CROSS-REFERENCE TO RELATED APPLICATION

This application is based upon and claims the benefit of priority of the prior Japanese Patent Application No. 2011-158026, filed on Jul. 19, 2011, the entire contents of which are incorporated herein by reference.

### FIELD

The embodiments discussed herein are related to a display system, a display apparatus, and a control method.

### BACKGROUND

Conventionally, there is used an external device which acquires image data produced from an information processing device and displays and controls it. For example, the external device projects an image on a screen based on image data. Alternatively, the external device allows a display included in its own device to display an image based on the image data. When using such an external device, an image can be displayed on a large screen or display. For example, in the case where performing a presentation, the external device is available at the time of viewing the same screen with respect to a number of persons.

Incidentally, in an information processing device, a function of a screen saver may be effective. When an operation is not performed to the information processing device for a predetermined time, the screen saver changes an operation screen into another screen. When an image is displayed by using an external device, a displayed screen is changed into another screen through the external device. During a presentation, for example, when a screen of the presentation is changed into another screen, it is interrupted.

To cope with the problem, a screen is considered to be suppressed from being changed by a screen saver. For example, a display device connected to an information processing device is proposed to generate code data to simulate a control signal produced from an input device such as a mouse and a keyboard and transmit it to the information processing device. Through the code data, for example, the information processing device receives an operation input from a mouse, and a screen is suppressed from being changed by a screen saver.
Japanese Laid-open Patent Publication No. 2008-70434
Japanese Laid-open Patent Publication No. 2007-219170

In the above-described method, however, a lot of trouble is taken to use a function of suppressing a screen change. For example, a lot of trouble is taken to add to an information processing device a function of handling code data transmitted by a display device as a signal from an input device. In addition, for example, a lot of trouble is taken to separately provide a communication path for transmitting and receiving the code data between the display device and the information processing device.

### SUMMARY

In one aspect of the embodiments, there is provided a display system. This display system includes an information processing apparatus having an image output unit configured to output image data; and an image output controller configured to control the image output unit so as to switch a display state of an image to a predetermined display state in the case where a connection signal is not received again only for a predetermined time after detecting connection of another device by receiving the connection signal, and a display apparatus having an interface unit configured to receive image data produced from the image output unit of the information processing apparatus; a display unit configured to display an image based on the image data received by the interface unit; and a controller configured to receive a setting input of a period shorter than the predetermined time and allow the interface unit to repeatedly output the connection signal at the set period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a display apparatus according to a first embodiment;

FIG. 2 illustrates a projection system according to a second embodiment;

FIG. 3 illustrates a hardware example of a projection apparatus;

FIG. 4 illustrates a hardware example of a client apparatus;

FIG. 5 illustrates an example of a pin arrangement of a DVI connector;

FIG. 6 is a block diagram illustrating functions of a projection apparatus;

FIG. 7 illustrates an example of an HPD controller;

FIG. 8 illustrates an example of connection detection through a hot plug;

FIG. 9 is a block diagram illustrating functions of a client apparatus;

FIG. 10 illustrates an example of a buffer control flag;

FIG. 11 is a flowchart illustrating projection processing;

FIG. 12 is a flowchart illustrating storage processing of image data in a buffer;

FIG. 13 is a first sequence diagram illustrating normal display processing at the time when there is no image change;

FIG. 14 is a sequence diagram illustrating disconnection/connection processing;

FIG. 15 is a second sequence diagram illustrating projection processing after disconnection/connection processing;

FIG. 16 illustrates a suppression example of a screen change by using a screen saver processing unit.

FIG. 17 illustrates an example of a display system according to a third embodiment; and

FIG. 18 illustrates a hardware example of a monitoring device.

### DESCRIPTION OF EMBODIMENTS

Hereinafter, preferred embodiments of the present invention will now be described in detail below with reference to the accompanying drawings, wherein like reference numerals refer to like elements throughout.

### First Embodiment

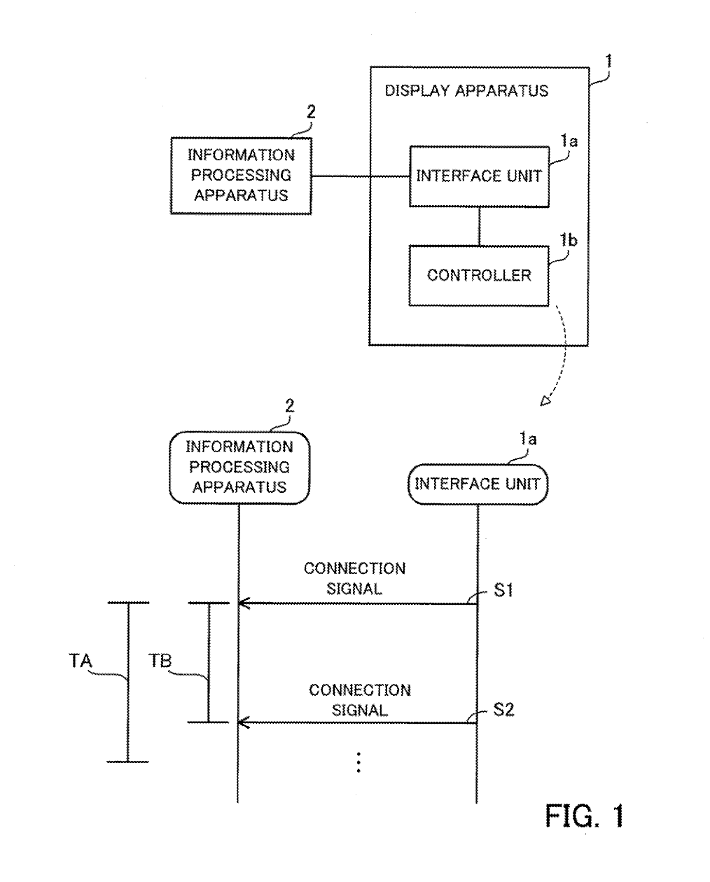

FIG. 1 illustrates a display apparatus according to a first embodiment. The display apparatus 1 is connected to an information processing apparatus 2, and supplies an image based on image data produced from the information processing apparatus 2. Examples of the display apparatus 1 include a display and projector equipped with a display surface of images by itself, and a projector which displays an image on an external display surface.

The information processing apparatus 2 has a function of switching a display state of an image to be output to a predetermined display state when a predetermined event is not yet detected only for a predetermined time TA after detecting the event. Examples of the above-described function include a screen saver function of switching an image to a predetermined image, and an automatic output off function of switching a display state so as not to output an image signal.

The predetermined event includes at least reception of a connection signal for detecting connection of other device. Namely, for example, when receiving connection signals from the display apparatus 1, the information processing apparatus 2 detects the connection of the display apparatus 1. In addition, examples of the predetermined event may include an input of signals from an input device such as a mouse or keyboard connected to the information processing apparatus 2.

The display apparatus 1 has an interface unit 1a and a controller 1b.

The interface unit 1a is an interface for receiving image data produced from the information processing apparatus 2. The interface unit 1a is connected via a predetermined cable to an interface unit for outputting image data included in the information processing apparatus 2. For example, the interface unit 1a may be realized by using a D-sub (D-subminiature) with a DVI (Digital Visual Interface), HDMI (High-Definition Multimedia Interface; trademark), Display Port, and VESA DDC (Video Electronics Standards Association Display Data Channel) signal line.

The interface unit 1a supplies a connection signal to the information processing apparatus 2.

The controller 1b receives a setting input of a period TB, and allows the interface unit 1a to repeatedly supply the connection signal at the set period TB. Every when the connection signal is supplied under the control of the controller 1b, the controller 1b allows the information processing apparatus 2 to detect that the display apparatus 1 is connected to the information processing apparatus 2. Here, when the period TB is set to a time shorter than the predetermined time TA, a display state of images produced from the information processing apparatus 2 is suppressed from being switched into the predetermined display state.

First, for example, the controller 1b allows the interface unit 1a to supply the connection signals (Step S1). At this time, the information processing apparatus 2 detects a reception event of the connection signals and resets a count of the time TA. On the other hand, when the time TB elapses from transmission of the connection signals, the controller 1b allows the interface unit 1a to supply the connection signals (Step S2). The information processing apparatus 2 detects the reception event of the connection signals again and resets a count of the time TA.

As described above, output processing of the connection signal from the interface unit 1a is performed at the period TB. At the period TB shorter than the time TA, when the information processing apparatus 2 detects the connection of the display apparatus 1, a display state of the image produced from the information processing apparatus 2 is suppressed from being switched to a predetermined display state.

Through the process, the display state is easily suppressed from being changed. Specifically, an event of the connection detected by the information processing apparatus 2 generally occurs at the time of connecting the display apparatus 1 and the information processing apparatus 2 and starting using them (e.g., hot plug and plug and play). Therefore, use of the event saves the trouble of separately adding a function of processing special information to the information processing apparatus 2. When using the event, a suppression function of changing a display state is further realized by using an interface for inputting and outputting an image normally used between the display apparatus 1 and the information processing apparatus 2. For that purpose, the use of the event saves the trouble of separately providing a communication path for transmitting and receiving special information.

As the connection signal, for example, there is used a signal which is turned on at the time of indicating that the display apparatus 1 is placed in the connection state and which is turned off at the time of indicating that the display apparatus 1 is placed in the disconnection state. In this case, an event of receiving the connection signal corresponds to the fact that a signal is turned off to on. For example, a signal is turned on after being once turned off at each of the steps S1 and S2.

### Second Embodiment

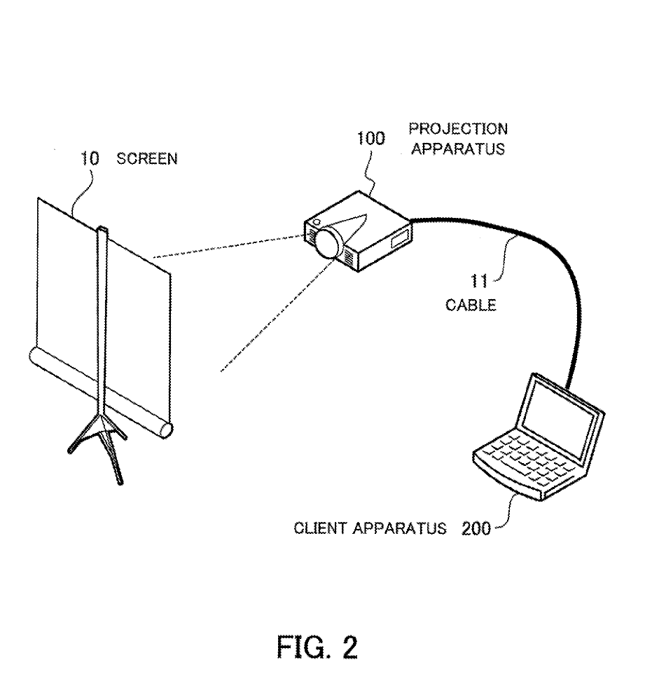

FIG. 2 illustrates a projection system according to a second embodiment. This projection system includes a projection apparatus 100 and a client apparatus 200.

The projection apparatus 100 is a projection apparatus which projects an image on a screen 10 based on image data produced from the client apparatus 200. The projection apparatus 100 is connected to the client apparatus 200 via a cable 11.

Here, the cable 11 is a cable for inputting and outputting image data. The cable 11 is supposed to be a DVI cable. Note that the cable 11 may be a cable for digital communication other than an HDMI cable and Display Port cable. Further, it is not limited to a cable for digital communication, and may be a cable for analog communication. For example, a D-sub cable corresponding to DDC may be used.

The client apparatus 200 is an information processing apparatus which outputs image data at a predetermined frame period. The client apparatus 200 has a screen saver function. The screen saver function is implemented, for example, by using an OS (Operating System) or predetermined software installed on the client apparatus 200. When a state where a predetermined event is not present with respect to the client apparatus 200 is kept for a predetermined time, the screen saver changes image data produced from the client apparatus 200 into predetermined image data. This event includes an event such as an operation input of a user and connection of an external device. The screen saver measures a time when the event is not continuously detected. When the measured time reaches a predetermined waiting time, the screen saver changes the image data. On the other hand, when detecting the event before reaching the waiting time, the screen saver resets a time during the measurement and restarts it.

The projection apparatus 100 and the client apparatus 200 correspond to a hot plug function, respectively. When the projection apparatus 100 is turned on, the projection apparatus 100 and the client apparatus 200 are physically connected via the cable 11. At this time, the projection apparatus 100 transmits an HPD (Hot Plug Detect) signal to the client apparatus 200. When the client apparatus 200 receives the HPD signal, the screen saver detects it as an event of connection of external devices.

By using this projection system, a user allows the projection apparatus 100 to project images produced from the client apparatus 200 on the screen 10. This projection system is used, for example, at the time of performing a presentation.

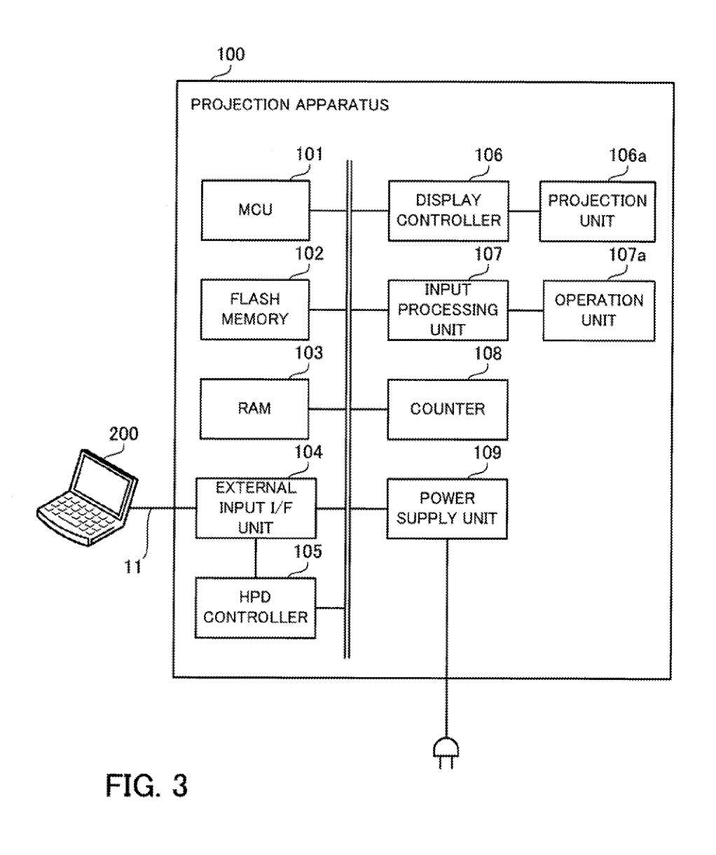

FIG. 3 illustrates a hardware example of the projection apparatus. The projection apparatus 100 has an MCU (Micro Control Unit) 101, a flash memory 102, a RAM (Random Access Memory) 103, an external input I/F (Interface) unit 104, an HPD controller 105, a display controller 106, a projection unit 106a, an input processing unit 107, an operation unit 107a, a counter 108, and a power supply unit 109.

The MCU 101 contains a CPU (Central Processing Unit) and a memory. The MCU 101 implements an OS program and a firmware program, and controls the entire projection apparatus 100.

The flash memory 102 stores an OS program, a firmware program, various types of data used in processing of the MCU 101. An OS program and firmware program may be stored in a memory built-in the MCU 101. The flash memory 102 may be other types of nonvolatile storage devices such as an HDD.

The RAM 103 temporarily stores at least a part of an OS program and firmware program executed by the MCU 101. In addition, the RAM 103 temporarily stores at least a part of data used in the processing of the MCU 101.

The external input I/F unit 104 has a DVI connector for connecting to the cable 11. The external input I/F unit 104 is physically connected to the client apparatus 200 via the cable 11. The external input I/F unit 104 receives image data to be produced from the client apparatus 200. The external input I/F unit 104 corresponds to a hot plug function, and transmits an HPD signal to the client apparatus 200.

The HPD controller 105 controls the external input I/F unit 104 to transmit an HPD signal to the client apparatus 200.

The display controller 106 is connected to the projection unit 106a. Based on the image data supplied to the external input I/F unit 104, the display controller 106 allows the projection unit 106a to project an image on the screen 10.

The input processing unit 107 is connected to the operation unit 107a. The operation unit 107a has buttons for receiving an operation input through a user. The input processing unit 107 supplies an input signal produced from the operation unit 107a to the MCU 101.

The counter 108 is a counter for measuring time. The counter 108 is used at the time when the MCU 101 measures time.

The power supply unit 109 is connected to a power supply via a power cable, and supplies power to each unit of the projection apparatus 100.

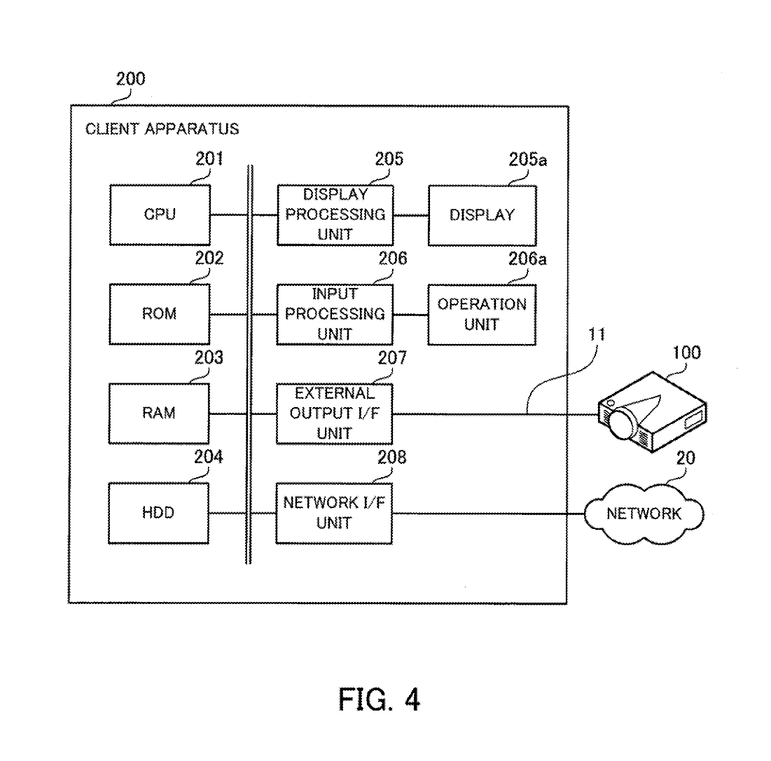

FIG. 4 illustrates a hardware example of the client apparatus. The client apparatus 200 has a CPU 201, a ROM (Read Only Memory) 202, a RAM 203, an HDD 204, a display processing unit 205, a display 205a, an input processing unit 206, an operation unit 206a, an external output I/F unit 207, and a network I/F unit 208.

The CPU 201 executes an OS program and an application program and controls the entire client apparatus 200.

The ROM 202 stores a predetermined program such as a BIOS (Basic Input/Output System) program executed at the time of starting up the client apparatus 200. The ROM 202 may be a rewritable nonvolatile memory.

The RAM 203 temporarily stores at least a part of the OS program and application program executed by the CPU 201. In addition, the RAM 203 stores various data necessary for processing through the CPU 201.

The HDD 204 stores the OS program and application program. In addition, the HDD 204 stores data used in the processing of the CPU 201. In place of the HDD 204 (or, in conjunction with the HDD 204), other types of nonvolatile storage devices such as an SSD (Solid State Drive) may be used.

The display processing unit 205 is connected to the display 205a. The display processing unit 205 displays an image on the display 205a according to a command from the CPU 201.

The input processing unit 206 is connected to the operation unit 206a. Examples of the operation unit 206a include input devices such as a keyboard and a touch pad. The input processing unit 206 transmits to the CPU 201 a signal produced from the operation unit 206a.

The external output I/F unit 207 has a DVI connector for connecting to the cable 11. The external output I/F unit 207 is physically connected to the projection apparatus 100 via the cable 11. The external output I/F unit 207 transmits the image data generated by the CPU 201 to the projection apparatus 100. In addition, when receiving an HPD signal from the projection apparatus 100, the external output I/F unit 207 notifies the CPU 201 of that effect.

The network I/F unit 208 is connected to a network 20. The network I/F unit 208 performs data communication with other information processing apparatus via the network 20.

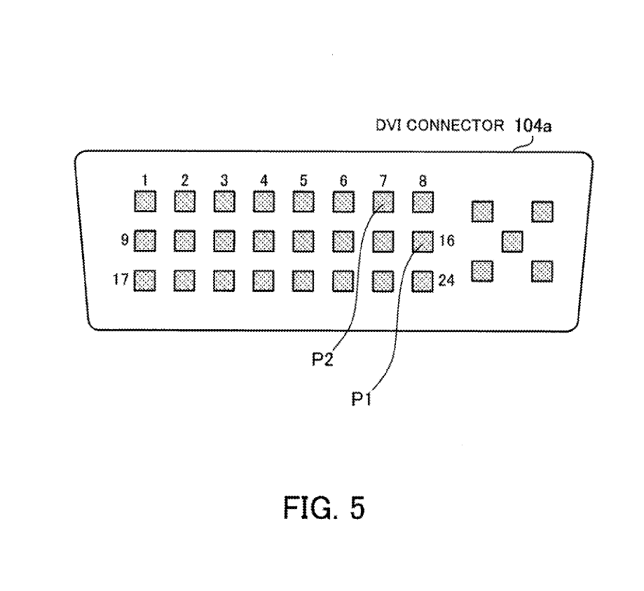

FIG. 5 illustrates an example of a pin arrangement of the DVI connector. The DVI connector 104a is provided on the external input I/F unit 104. Also, a DVI connector provided on the external output I/F unit 207 is illustrated in the same manner as in the DVI connector 104a. The DVI connector 104a is connected to a connector of a termination unit of the cable 11.

In the DVI connector 104a, a pin P1 (16-th pin) for an HPD signal line is provided. In the DVI connector 104a, a pin P2 for transmitting DDC data (seventh pin) is provided. As the DDC data, for example, unique data (a vendor name, a model number, and resolution) on the display apparatus is transmitted.

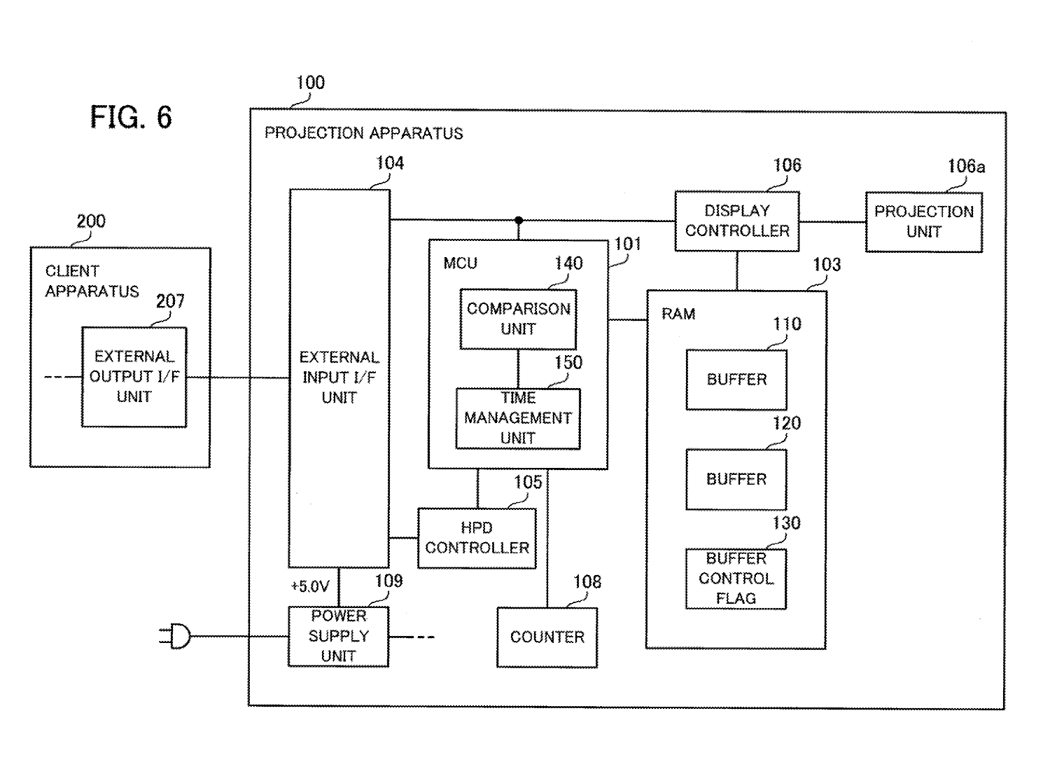

FIG. 6 is a block diagram illustrating functions of the projection apparatus. The projection apparatus 100 has buffers 110 and 120, a memory unit for a buffer control flag 130, a comparison unit 140, and a time management unit 150. The buffers 110 and 120, and the memory unit for the buffer control flag 130 are provided on the RAM 103. When the MCU 101 executes a predetermined program, the comparison unit 140 and the time management unit 150 are realized on the projection apparatus 100. Any one or both of the comparison unit 140 and the time management unit 150 may be realized by using special hardware.

The buffers 110 and 120 are memory units which store image data. The display controller 106 stores image data received in each frame from the client apparatus 200 in any one of the buffers 110 and 120. The display controller 106 may acquire image data from any one of the buffers 110 and 120 and supply it to the projection unit 106a.

The buffer control flag 130 is data for managing that the newly received image data is stored in any of the buffers 110 and 120. The display controller 106 refers to the buffer control flag 130, and identifies that the newly received image data is stored in any of the buffers 110 and 120.

When the newly received image data is stored in any of the buffers 110 and 120, the comparison unit 140 compares the image data sets in both the buffers and determines whether both the image data sets are matched with each other. The comparison unit 140 may determine whether both the image data sets are matched with each other in a rate of 100%, or only in a rate of a certain level (e.g., 99%). The comparison unit 140 supplies determination results to the time management unit 150.

By using the counter 108, the time management unit 150 measures time at which the image data sets in the buffers 110 and 120 are matched with each other. According to the measurement results, the time management unit 150 supplies a signal for controlling on and off of the HPD signal to the HPD controller 105. Hereinafter, the signal for controlling on and off of the HPD signal is referred to as an HPD# signal. For example, the MCU 101 has a GPIO (General Purpose Input/Output) interface, and is connectable to the HPD controller 105 through the GPIO. In that case, the time management unit 150 supplies the HPD# signal to the HPD controller 105 via the GPIO.

The power supply unit 109 supplies a power supply voltage of +5.0 V to the external input I/F unit 104.

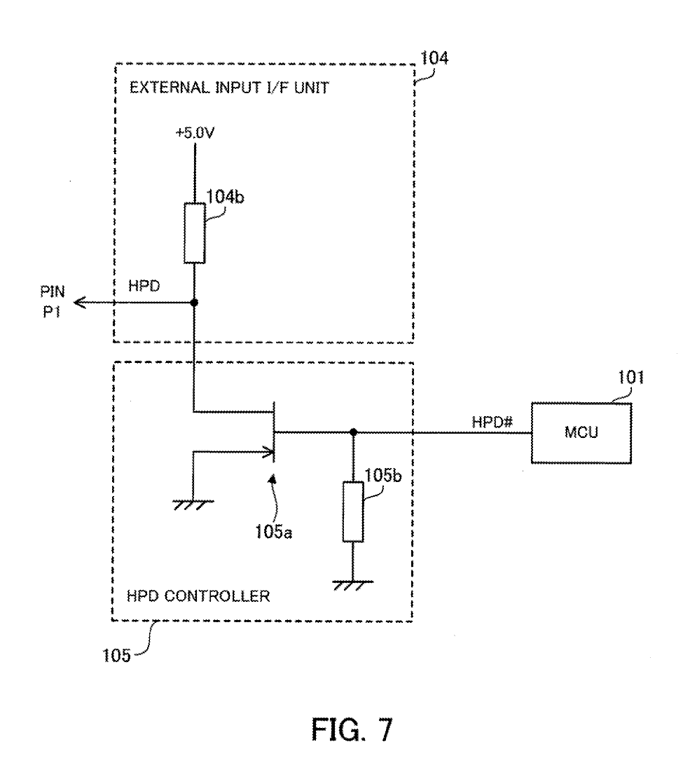

FIG. 7 illustrates an example of the HPD controller. The HPD controller 105 has an n (negative) channel FET (Field Effect Transistor) 105a and a resistor 105b.

According to a gate voltage, the FET 105a changes grounded or ungrounded of the HPD signal line of the external input I/F unit 104. The gate voltage is supplied through the HPD# signal produced from the MCU 101. The resistor 105b is a pull-down resistor for fixing a gate potential of zero V in the FET 105a.

In FIG. 7, a portion relating to the HPD signal of the external input I/F unit 104 also is partially illustrated. The external input I/F unit 104 has a resistor 104b. One end of the resistor 104b is connected to a power supply voltage supply line of +5.0 V from the power supply unit 109. The other end of the resistor 104b is connected to the pin P1 provided in the DVI connector 104a and a drain side of the FET 105a. A signal line of the side connected to the pin P1 of the resistor 104b is the HPD signal line.

For example, when the HPD signal is not controlled (normal times), the MCU 101 asserts the HPD# signal to be Low. As a result, the FET 105a is held in off state and the HDP signal line is held in an ungrounded state. The HPD signal is pulled up to a predetermined voltage by using the resistor 104b.

On the other hand, when the HPD signal is controlled, the MCU 101 asserts the HPD# signal to be High. As a result, the FET 105a is held in an on state, and the HPD signal line is held in a grounded state. Then, the HPD signal is held in an off state.

Next, a state of each signal at the time when the client apparatus 200 detects connection or disconnection to the projection apparatus 100 through the hot plug will be described.

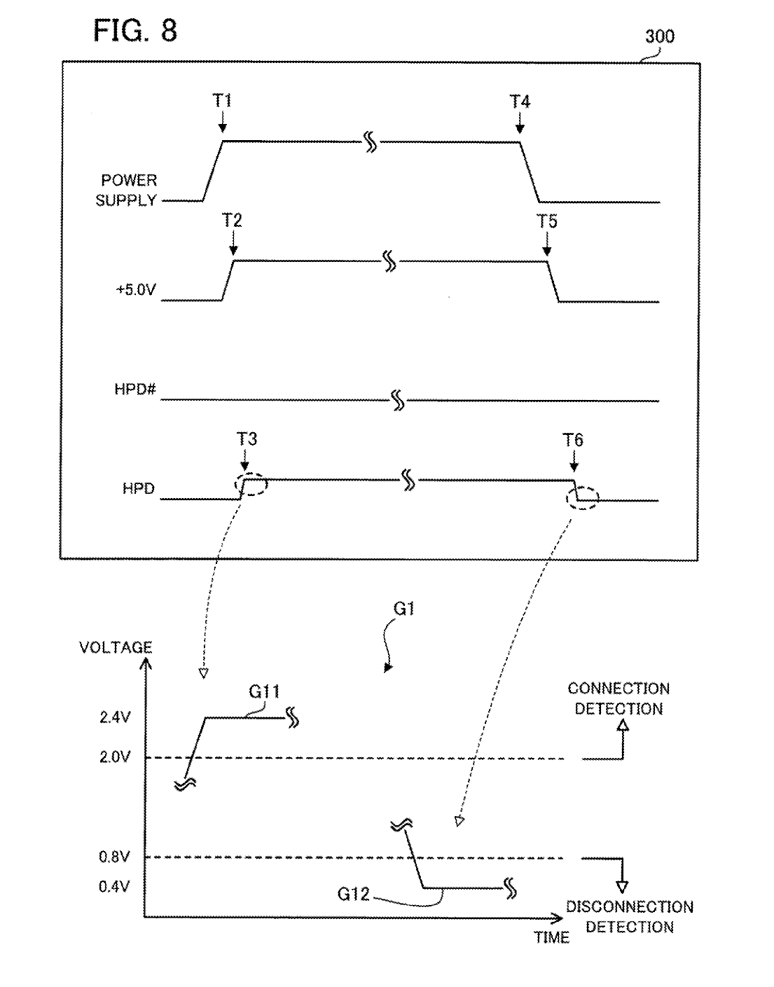

FIG. 8 illustrates an example of the connection detection through the hot plug. In a time chart 300, each waveform of the total output voltage of the power supply unit 109, the output voltage of +5.0 V supplied to the external input I/F unit 104 from the power supply unit 109, the HPD# signal produced from the MCU 101, and the HPD signal produced from the external input I/F unit 104 is illustrated in the order from the upper side of FIG. 8. In a graph G1, the horizontal axis represents the time, and the longitudinal axis represents the voltage, and the HPD signals near to steps T3 and T6 of the time chart 300 are illustrated.

Hereinafter, each step of the time chart 300 will be described. Suppose that the projection apparatus 100 and the client apparatus 200 are physically connected via the cable 11. Suppose further that in FIG. 8, the HPD# signal is always asserted to be Low.

First, the power supply unit 109 is connected to a power supply (e.g., AC (Alternating Current) 100V), and a power supply of the projection apparatus 100 is turned on (timing T1). An electricity supply to each unit through the power supply unit 109 is started, and a supply of power supply voltage of +5.0V is started to the external input I/F unit 104 (timing T2). The external input I/F unit 104 starts supplying the HPD signal G11 pulled up to a predetermined voltage by using a power supply voltage of +5.0V supplied from the power supply unit 109 and the resistor 104b (timing T3). For example, in the case where the client apparatus 200 detects the connection at the time of detecting the HPD signal of +2.0V or more, the HPD signal G11 indicates approximately +2.4V. Through the process, when detecting the connection to the projection apparatus 100, the client apparatus 200 performs preparation for starting using the projection apparatus 100 (e.g., setting of a driver). An image of the client apparatus 200 is projected on the screen 10 through the projection apparatus 100.

When the use of the projection apparatus 100 is finished, a power supply of the projection apparatus 100 is turned off (timing T4). An electricity supply to each unit through the power supply unit 109 is stopped, and also a supply of the power supply voltage of +5.0V to the external input I/F unit 104 is stopped (timing t5). In the external input I/F unit 104, a supply of the power supply voltage is stopped and the HPD signal is also turned off (timing T6). For example, when the HPD signal has a voltage of 0.8V or less, the client apparatus 200 detects that the connection between the projection apparatus 100 and its own apparatus is disconnected, and stops the use of the projection apparatus 100. Therefore, for example, when transmitting the HPD signal G12 of 0.4V or less, the external input I/F unit 104 moves the connection between the client apparatus 200 and its own apparatus to the disconnection state.

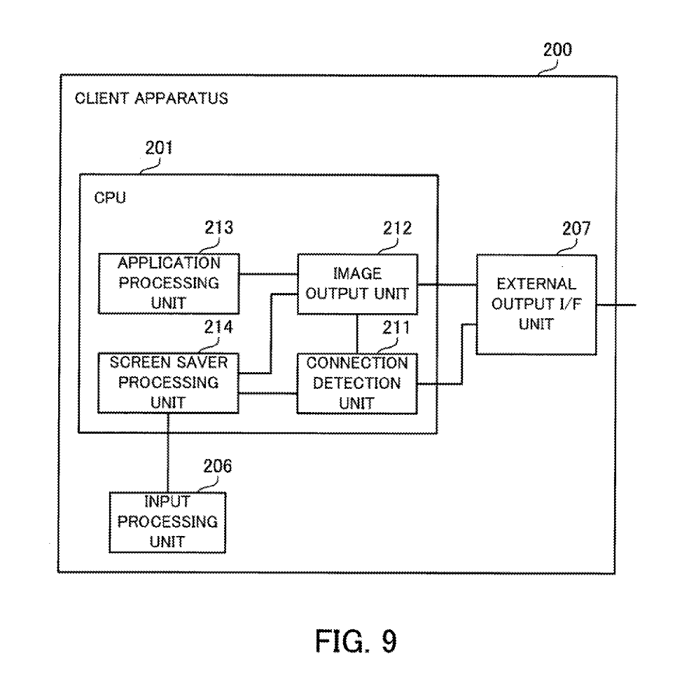

FIG. 9 is a block diagram illustrating functions of the client apparatus. The client apparatus 200 has a connection detection unit 211, an image output unit 212, an application processing unit 213, and a screen saver processing unit 214. For example, when the CPU 201 executes a predetermined program, each of these processing blocks is realized on the client apparatus 200.

The connection detection unit 211 and the image output unit 212 perform processing, for example, according to a driver program for controlling the external output I/F unit 207.

Based on the HPD signal supplied to the external output I/F unit 207, the connection detection unit 211 detects the connection of devices in the external output I/F unit 207. When the voltage of the HPD signal reaches +2.0V or more, the connection detection unit 211 recognizes that the devices are connected to the external output I/F unit 207. When recognizing that the devices are connected to the external output I/F unit 207, the connection detection unit 211 notifies the image output unit 212 of the connection of the device and supplies a device detection event to the screen saver processing unit 214.

When receiving a notification of the device connection from the connection detection unit 211, the image output unit 212 performs initial setting for producing the image data from the external output I/F unit 207. As the initial setting, for example, the image output unit 212 receives unique data on the connected devices through a seventh pin of the DVI connector. The image output unit 212 then performs setting of the display processing according to the received unique data, such as setting of resolution adapted to the connected device. When finishing the initial setting, the image output unit 212 starts output of the image data through the external output I/F unit 207.

The application processing unit 213 performs processing according to a predetermined application program, and generates the image information to be displayed on the display apparatus to supply it to the image output unit 212.

In the case where a predetermined time event is not detected, the screen saver processing unit 214 allows the image output unit 212 to display a predetermined screen saver image. Examples of the event detected by the screen saver processing unit 214 include an input event produced from the input processing unit 206 at the time of performing an input operation to the operation unit 206a and a device detection event produced from the connection detection unit 211.

When the screen saver processing unit 214 does not need a display of the screen saver image, the image output unit 212 generates image data based on image information produced from the application processing unit 213 and supplies it to the external output I/F unit 207. On the other hand, in the case where the screen saver processing unit 214 does not detect the predetermined time event, the image output unit 212 switches the previously supplied image data to that of the screen saver image according to the demand from the screen saver processing unit 214.

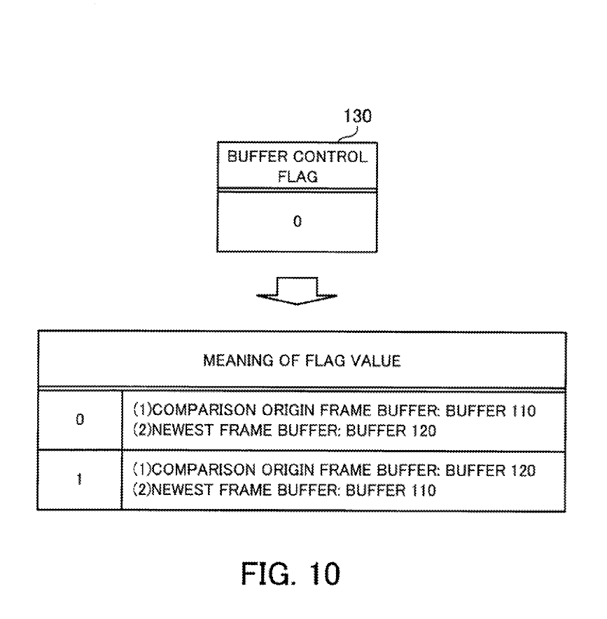

FIG. 10 illustrates an example of the buffer control flag. In the buffer control flag 130, a present flag value is set. A possible value of the flag value is zero or one, and meaning of each value is as follows.

The flag value “zero” indicates that the buffers 110 and 120 are handled as follows.

(1) At the time of comparing the image data sets, a buffer (hereinafter, referred to as a comparison origin frame buffer) in which the image data of a past frame as a comparison origin is to be stored is the buffer 110.

(2) A buffer (hereinafter, referred to as a newest frame buffer) in which the image data of a newly received newest frame is to be stored is the buffer 120.

The flag value “one” indicates that the buffers 110 and 120 are handled as follows.

(1) A comparison origin frame buffer is the buffer 120.

(2) A newest frame buffer is the buffer 110.

A process procedure of the projection apparatus 100 having the above-described configuration will be described below. In the following description, in the case where processing of the MCU 101 will be described, the comparison unit 140 and the time management unit 150 will be described as a main body of the processing.

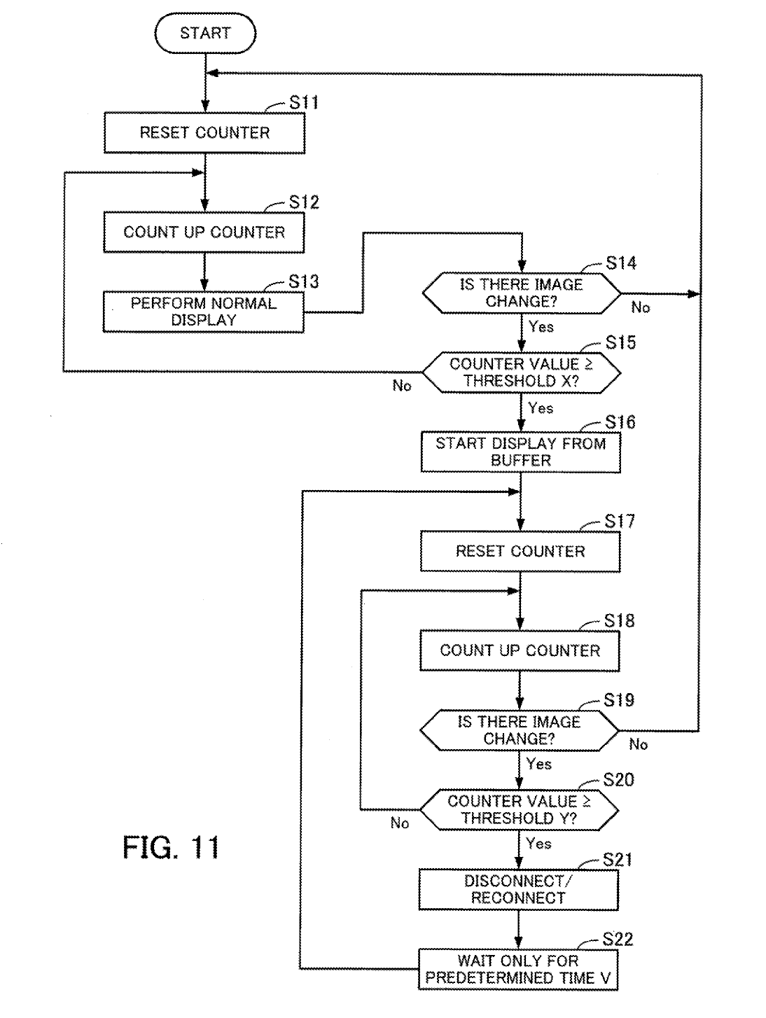

FIG. 11 is a flowchart illustrating projection processing. The process illustrated in FIG. 11 includes the following steps:

(Step S11) The time management unit 150 resets the counter 108.

(Step S12) The display controller 106 receives the image data from the client apparatus 200. The time management unit 150 then counts up the counter 108.

(Step S13) The display controller 106 supplies the received image data to the projection unit 106a, and allows the projection unit 106a to project it on the screen 10. With reference to the buffer control flag 130, the display controller 106 identifies the newest frame buffer in the buffers 110 and 120, and stores the newly received image data in the identified buffer.

(Step S14) The time management unit 150 inquires of the comparison unit 140 for determination results of the presence or absence of changes due to the newest image data. If a change in the image data is not present, the process advances to step S15. If a change in the image data is present, the process returns to step S11.

(Step S15) The time management unit 150 determines whether a count value of the counter 108 is larger than or equal to a threshold X. If so, the process advances to step S16. If not, the process returns to step S12. A matter that the threshold X is set to any level of the time is previously set in the time management unit 150. Suppose, for example, that the threshold X=10 sec.

(Step S16) The time management unit 150 instructs the display controller 106 to start producing images from the comparison origin frame buffer. When receiving the instruction, the display controller 106 identifies the comparison origin frame buffer with reference to the buffer control flag 130. Until a change in the image data is detected subsequently, the display controller 106 acquires the image data stored in the comparison origin frame buffer in timing of each frame, supplies it to the projection unit 106a, and allows the projection unit 106a to project it on the screen 10. In addition, the display controller 106 stores the image data newly received from the client apparatus 200 in the newest frame buffer (the newly received image data is only stored in the newest frame buffer and the image is not projected).

(Step S17) The time management unit 150 resets the counter 108.

(Step S18) The display controller 106 receives the image data from the client apparatus 200. The time management unit 150 then counts up the counter 108. The display controller 106 stores the received image data in the newest frame buffer.

(Step S19) The time management unit 150 inquires of the comparison unit 140 for determination results of the presence or absence of changes due to the newest image data. If a change in the image data is not present, the process advances to step S20. If a change in the image data is present, the process returns to step S11. At this time, the time management unit 150 instructs the display controller 106 to supply the image data newly received at step S18 to the projection unit 106a. Through the instruction, the display controller 106 supplies the newly received image data to the projection unit 106a, and allows the projection unit 106a to project it on the screen 10 (a display through the display controller 106 is switched into a normal display, specifically, a display for projecting a received newest image data).

(Step S20) The time management unit 150 determines whether a count value of the counter 108 is larger than or equal to a threshold Y. If so, the process advances to step S21. If not, the process returns to step S18. As the threshold Y, the time shorter than the waiting time until the screen saver processing unit 214 of the client apparatus 200 performs an image change is previously set in the time management unit 150.

(Step S21) The time management unit 150 turns on the HPD# signal, turns on the FET 105a of the HPD controller 105, and turns off the HPD signal. As a result, the connection between the projection apparatus 100 and the client apparatus 200 is disconnected. The time management unit 150 turns off the HPD# signal, turns off the FET 105a of the HPD controller 105, and turns on the HPD signal. As a result, the projection apparatus 100 and the client apparatus 200 are reconnected to each other.

(Step S22) The time management unit 150 waits only for a predetermined time V. The above waiting is performed so as not to reflect a disturbance of an output image along with an initialization of the driver setting at the time when the client apparatus 200 starts using the projection apparatus 100 on the image projected by the projection apparatus 100. For example, it is preferred that the time management unit 150 waits for approximately V=1 sec. When the time of approximately one sec elapses, the output image from the client apparatus 200 is considered to become stable. According to the time required for initial processing in the client apparatus 200, the time V may be changed. When the predetermined time V elapses, the process returns to step S17.

In the processing of FIG. 11, when time elapses by the threshold X without changing the output image from the client apparatus 200, the projection apparatus 100 starts projecting an image by using the buffers 110 and 120. In that state, when time further elapses by the threshold Y, the projection apparatus 100 subjects the connection to the client apparatus 200 to disconnection/reconnection.

Here, according to an input operation from the operation unit 206a, values of the thresholds X and Y are previously set in a predetermined memory unit (e.g., the flash memory 102) of the projection unit 100. These values of the thresholds X and Y are set according to waiting time Z until the screen saver processing unit 214 of the client apparatus 200 switches the output image. Suppose specifically that X+Y<Z.

When a loop process of steps S17 to S22 is continuously performed, the threshold Y may be changed at the time of performing the first disconnection/reconnection at step S20, or at the time of performing the second disconnection/reconnection or later. Specifically, a threshold of step S20 at the time of performing the first disconnection/reconnection may be set to Y1 so that X+Y1<Z can be satisfied, and then the same threshold at the time of performing the second disconnection/reconnection or later may be changed to Y2 so that Y2<Z (namely, a condition of X+Y<Z is not imposed on Y2) can be satisfied. When the above-described method is adopted, Y2 is taken larger than Y1, and therefore a period at the time of performing the second disconnection/reconnection or later is suppressed from becoming excessively short.

At this time, when considering the waiting time V at step S22, the threshold Y2 is preferably determined so as to become equal to X+Y1−V. The reason is that timings for performing the first and second disconnection/reconnection or later are set to have the same period.

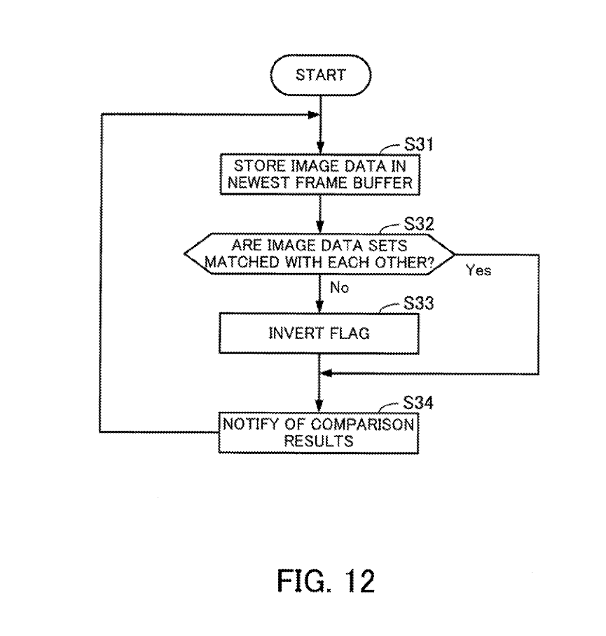

FIG. 12 is a flowchart illustrating storage processing of the image data in the buffer. The process illustrated in FIG. 12 includes the following steps:

(Step S31) The display controller 106 supplies the received image data to the projection unit 106a, and allows the projection unit 106a to project an image on the screen 10. With reference to the buffer control flag 130, the display controller 106 identifies the newest frame buffer in the buffers 110 and 120, and stores the newly received image data in the identified buffer. Processing of step S31 is the same processing as synchronized with that of step S13 of FIG. 11.

(Step S32) The comparison unit 140 determines whether the image data stored in the comparison origin frame buffer and the image data stored in the newest frame buffer are matched with each other. If not (in the case where there is a change in the image data), the process advances to step S33. If so (in the case where there is no change in the image data), the process proceeds to step S34.

(Step S33) The comparison unit 140 inverts setting of the buffer control flag 130. Specifically, if a present flag value is “zero”, the flag value is updated to “one”. On the other hand, if a present flag value is “one”, the flag value is updated to “zero”.

(Step S34) When receiving from the time management unit 150 an inquiry whether there is a change in the image data, the comparison unit 140 responds the determination results of step S32 to the time management unit 150. The processing of step S34 is processing synchronized with that of step S14 of FIG. 11. The process then returns to step S31.

As can be seen from the above sequence, the comparison unit 140 determines whether the image data sets in the buffers 110 and 120 are matched with each other, and notifies the time management unit 150 of the determination results. At the same time, the comparison unit 140 updates the setting of the buffer control flag 130 according to the determination results. Through the process, the display controller 106 correctly determines whether any of the buffers 110 and 120 are the comparison origin frame buffer or the newest frame buffer.

Next, a specific flow of the process will be described.

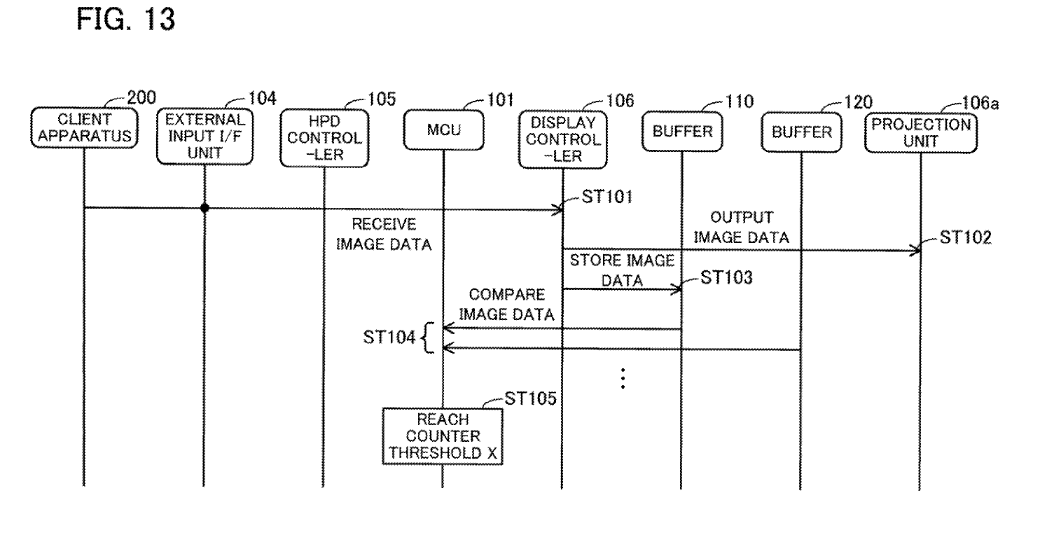

FIG. 13 is a first sequence diagram illustrating normal display processing at the time when there is no change in the image. Immediately before step ST101, the buffer 110 is supposed to be the newest frame buffer and the buffer 120 is supposed to be the comparison origin frame buffer. In the buffer 120, the image data received from the client apparatus 200 before step ST101 is stored. The process illustrated in FIG. 13 includes the following steps:

(Step ST101) The display controller 106 receives the image data of the newest frame from the client apparatus 200 via the external input I/F unit 104. The MCU 101 counts up the counter 108.

(Step ST102) The display controller 106 supplies the received image data to the projection unit 106a and allows the projection unit 106a to project it on the screen 10.

(Step ST103) The display controller 106 stores the received image data in the buffer 110 being the newest frame buffer.

(Step ST104) The MCU 101 compares both the image data sets stored in the buffers 110 and 120. Suppose that both the image data sets are matched with each other.

Subsequently, the processing of the steps ST101 to ST104 is repeated (until detection of step ST105 is performed).

(Step ST105) The MCU 101 detects that a count value of the counter 108 reaches the threshold X. The MCU 101 then instructs the display controller 106 to start producing an image from the buffer 120 being the comparison origin frame buffer.

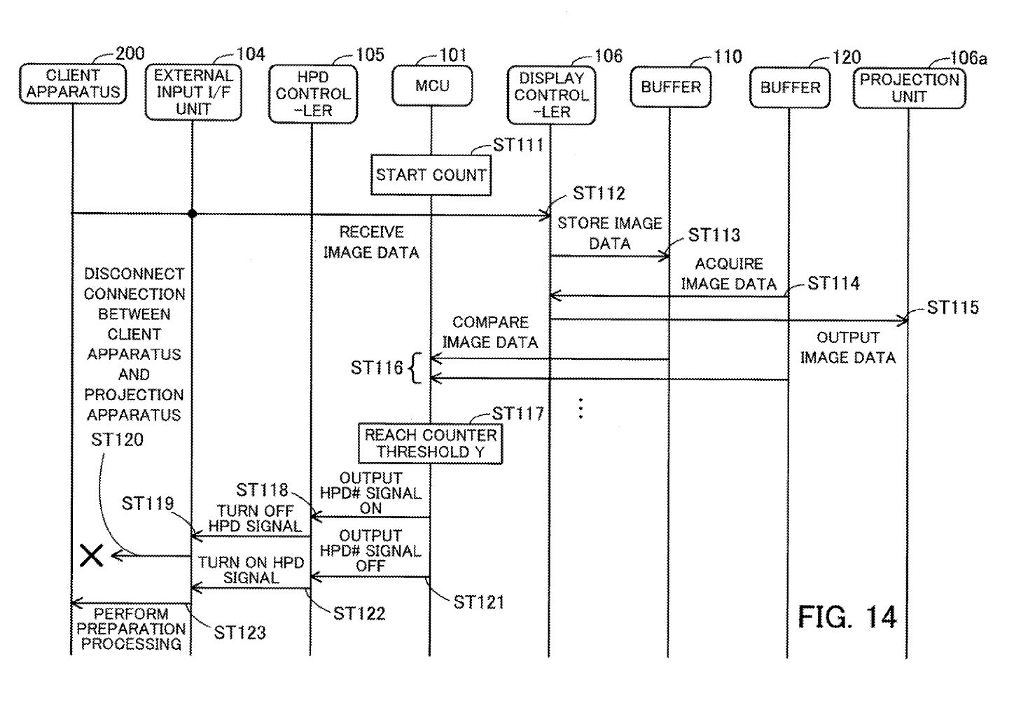

Next, the process illustrated in FIG. 14 is started.

FIG. 14 is a sequence diagram illustrating the disconnection/connection processing. Succeeding to FIG. 13, the buffer 110 is the newest frame buffer, and the buffer 120 is the comparison origin frame buffer. The process illustrated in FIG. 14 includes the following steps:

(Step ST111) The MCU 101 resets the counter 108 and starts a count.

(Step ST112) The display controller 106 receives the image data of the newest frame from the client apparatus 200 via the external input I/F unit 104. The MCU 101 counts up the counter 108.

(Step ST113) The display controller 106 stores the received image data in the buffer 110 being the newest frame buffer.

(Step ST114) The display controller 106 acquires the image data from the buffer 120 being the comparison origin frame buffer.

(Step ST115) The display controller 106 supplies the image data acquired from the buffer 120 to the projection unit 106a and allows the projection unit 106a to project it on the screen 10.

(Step ST116) The MCU 101 compares both the image data sets stored in the buffers 110 and 120. Suppose that both the image data sets are matched with each other.

Subsequently, the processing of the steps ST112 to ST116 is repeated (until detection of step ST117 is performed).

(Step ST117) The MCU 101 detects that a count value of the counter 108 reaches the threshold Y.

(Step ST118) The MCU 101 supplies an HPD# signal on to the HPD controller 105.

(Step ST119) In the HPD controller 105, the FET 105a is turned on. As a result, the HPD signal produced from the external input I/F unit 104 is turned off.

(Step ST120) When detecting an HPD signal off, the client apparatus 200 performs a process of disconnecting the connection to the projection apparatus 100.

(Step ST121) The MCU 101 supplies an HPD# signal off to the HPD controller 105.

(Step ST122) In the HPD controller 105, the FET 105a is turned off. As a result, an HPD signal produced from the external input I/F unit 104 is turned on.

(Step ST123) When detecting the HPD signal on, the client apparatus 200 performs preparation processing (initialization of setting) for using the projection apparatus 100.

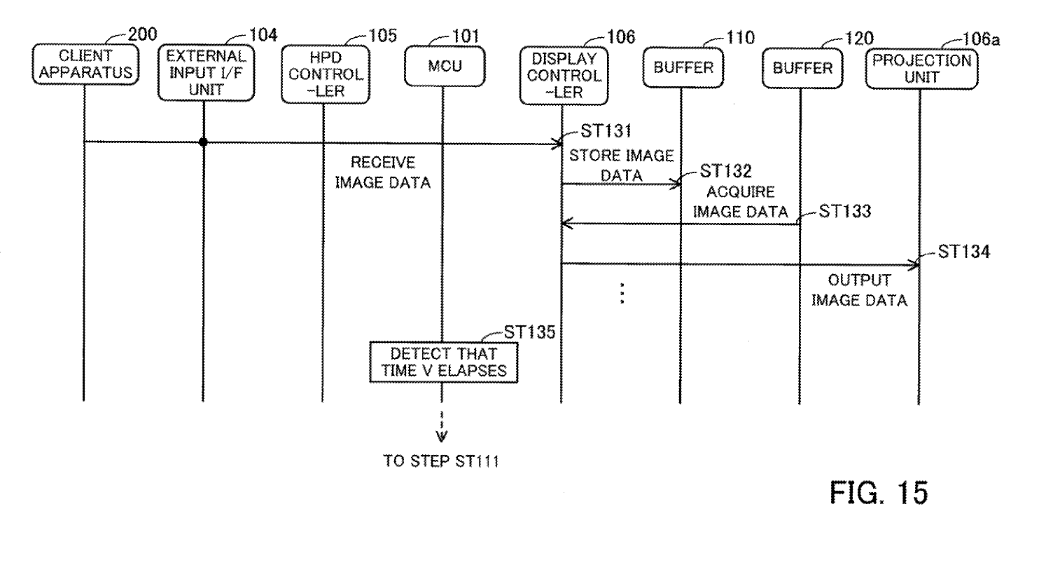

The process illustrated in FIG. 15 is then started.

FIG. 15 is a second sequence diagram illustrating the projection processing after the disconnection/connection processing. Succeeding to FIGS. 13 and 14, the buffer 110 is the newest frame buffer, and the buffer 120 is the comparison origin frame buffer. The process illustrated in FIG. 15 includes the following steps:

(Step ST131) The display controller 106 receives the image data of the newest frame from the client apparatus 200 via the external input I/F unit 104.

(Step ST132) The display controller 106 stores the received image data in the buffer 110 being the newest frame buffer.

(Step ST133) The display controller 106 acquires the image data from the buffer 120 being the comparison origin frame buffer.

(Step ST134) The display controller 106 supplies the image data acquired from the buffer 120 to the projection unit 106a and allows the projection unit 106a to project it on the screen 10.

Subsequently, the processing of the steps ST131 to ST134 is repeated (until detection of step ST135 is performed).

(Step ST135) After the processing of step ST123 of FIG. 14, the MCU 101 detects that the time V elapses. The MCU 101 then starts the processing of step ST111 of FIG. 14. The MCU 101 may measure the time V by using the counter 108.

The above steps permit the projection apparatus 100 to regularly perform disconnection/reconnection of the connection to the client apparatus 200 in the case where there is no change in the output image from the client apparatus 200. At this time, when the image from the buffers 110 and 120 is projected, a disturbance of the images at the time of disconnection/reconnection is suppressed from being reflected on the images projected by the projection apparatus 100. For example, when the HDP signal is turned on after turned off, the image output unit 212 of the client apparatus 200 performs initial setting for outputting images. At this time, a disturbance of images is caused by a temporary stoppage of the image data output from the image output unit 212, or a change in the display setting. As compared with the above, at the time when the HPD signal is turned on after turned off, when the images from the buffers 110 and 120 are projected, a disturbance of the projected images is suppressed.

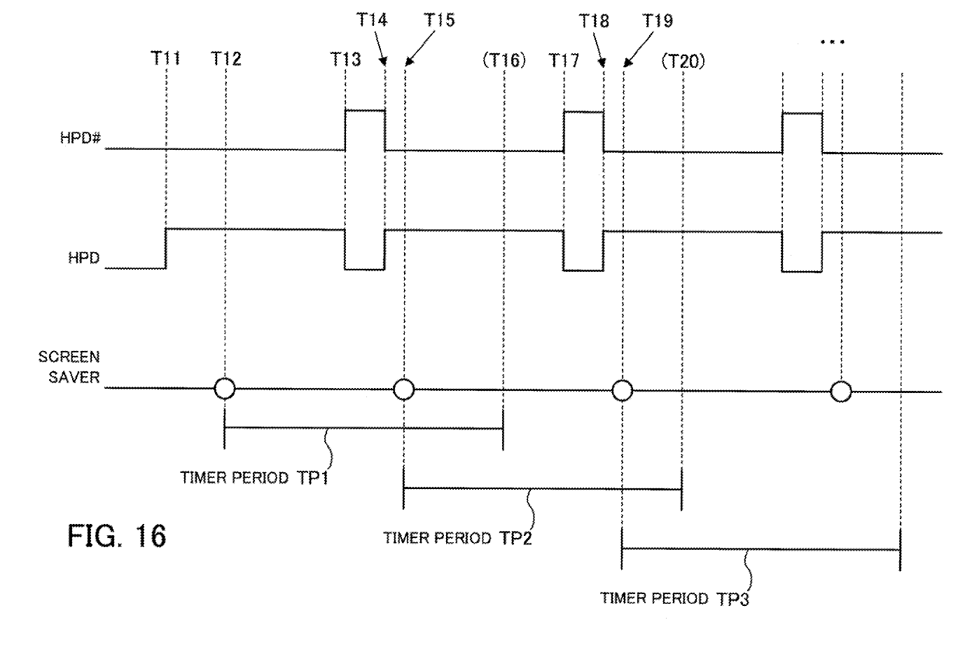

FIG. 16 illustrates a suppression example of a screen change by using the screen saver processing unit. The projection apparatus 100 is connected to the client apparatus 200 with power turned on. The projection apparatus 100 then outputs the HPD signal on to the client apparatus 200 (timing T11). The HPD# signal is off at timing T11. When detecting a predetermined event (for example, an input signal from a mouse connected to the client apparatus 200), the screen saver processing unit 214 of the client apparatus 200 resets a waiting time (counts of a timer period) up to a screen change. The count of the timer period TP1 through the screen saver processing unit 214 is started (timing T12).

Subsequently, since there continues the time when there is no change in the output image from the client apparatus 200, the projection apparatus 100 turns on the HPD# signal. At the time, the HPD signal is turned off (timing T13). Immediately after the timing T13, the connection between the projection apparatus 100 and the client apparatus 200 is disconnected.

The projection apparatus 100 turns off the HPD# signal. At the time, the HPD signal is turned on (timing T14). The projection apparatus 100 and the client apparatus 200 are reconnected to each other. Through the event of the reconnection, a count of the timer period TP1 of the screen saver processing unit 214 is reset, and a count of the timer period TP2 is newly started (timing T15).

When the reconnection is supposed to be not performed at timing T15, timing T16 indicates timing when the timer period TP1 is fulfilled and the image change through the screen saver processing unit 214 is performed (much the same is true on timings T20 and T24 subsequently indicated). In FIG. 16, since an event of the reconnection occurs before fulfilling the timer period TP1, there is no change in the image at the timing T16.

Since there further continues the time when there is no change in the output image from the client apparatus 200, the projection apparatus 100 turns on the HPD# signal. At the time, the HPD signal is turned off (timing T17). Immediately after the timing T17, the connection between the projection apparatus 100 and the client apparatus 200 is disconnected.

The projection apparatus 100 turns off the HPD# signal. At the time, the HPD signal is turned on (timing T18). The projection apparatus 100 and the client apparatus 200 are reconnected to each other. Through the event of the reconnection, a count of the timer period TP2 of the screen saver processing unit 214 is reset, and a count of the timer period TP3 is newly started (timing T19). The screen change of timing T20 is not performed in the same manner as in the timing T16.

Subsequently, while there is no change in the output image from the client apparatus 200, the processing illustrated in the timings T17 to T19 is repeatedly performed.

In an example of FIG. 16, the timer period is supposed to be reset at the timings T13 and T19 when the screen saver processing unit 214 is reconnected. Further, the timer period may be reset at the timing when the connection is disconnected.

As can be seen from the above sequence, in the projection apparatus 100 according to the second embodiment, the screen saver processing unit 214 of the client apparatus 200 easily suppresses the images from being changed. Specifically, the event of a generally used hot plug or plug and play is available for an event at the time of connecting the projection apparatus 100 and the client apparatus 200. Accordingly, the use of the connection event saves the trouble of separately adding to the client apparatus 200 a function of processing special information to suppress the screen change through the screen saver processing unit 214. When using the event, a suppression function of the screen change is available by using an interface for inputting and outputting an image normally used between the projection apparatus 100 and the client apparatus 200. Therefore, unlike the conventional method, the use of the event saves the trouble of separately providing a communication path for transmitting and receiving special information.

The projection apparatus 100 further stores the image data received from the client apparatus 200 in the buffers 110 and 120, and switches to a mode of regularly performing disconnection/reconnection at the time when there is no change in the output image from the client apparatus 200. When there is no change in the output image from the client apparatus 200 for a predetermined period, there is a high possibility that an operation input to the client apparatus 200 is not performed, and that the image is changed by the screen saver processing unit 214. As a result, also when there is a low possibility that the image is changed by the screen saver processing unit 214, processing of the disconnection/reconnection is suppressed.

In the case where there is no change in the output image from the client apparatus 200, the projection apparatus 100 performs projection by using the image data stored in the buffers 110 and 120. Particularly, after performing the disconnection/reconnection, the projection apparatus 100 waits only for the predetermined time V, and then restarts comparison of the images. As a result, when the client apparatus 200 prepares the start of use of the projection apparatus 100 during the disconnection/reconnection, even if a disturbance is generated in the output image from the client apparatus 200, the display system suppresses an influence of the disturbance from being exerted on the image projected by the projection apparatus 100.

### Third Embodiment

In the second embodiment, the projection system is described with reference to the example. Further, a suppression function of the screen change through the screen saver may be applied to a display system in which a display apparatus is connected to the client apparatus 200. Hereinafter, a display system will be described with reference to examples.

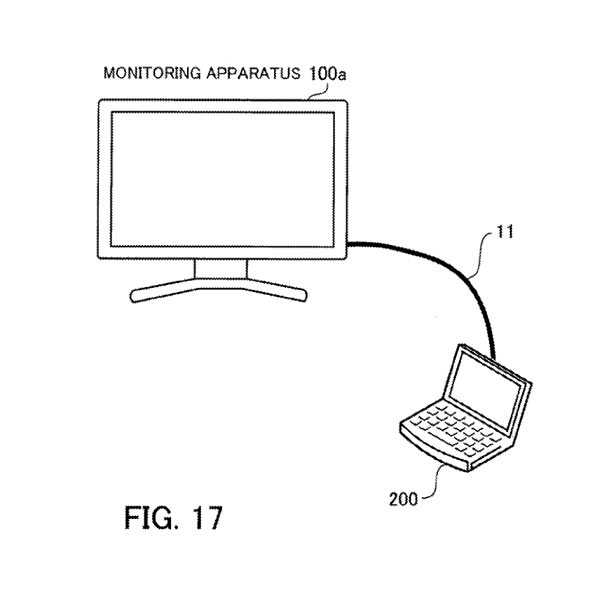

FIG. 17 illustrates an example of a display system according to a third embodiment. This display system includes a monitoring apparatus 100a and the client apparatus 200.

The monitoring apparatus 100a is a display apparatus which displays an image on a display included in its own apparatus based on image data produced from the client apparatus 200. The monitoring apparatus 100a is connected to the client apparatus 200 via the cable 11.

Here, a point that a DVI cable, an HDMI cable, a Display port cable, and a D-sub cable corresponding to DDC are available for the cable 11 is as described in FIG. 2.

The monitoring apparatus 100a corresponds to a hot plug function in the same manner as in the projection apparatus 100. In the case where the monitoring apparatus 100a is in a state of power on, when the monitoring apparatus 100a and the client apparatus 200 are physically connected via the cable 11, the monitoring apparatus 100a transmits an HPD signal to the client apparatus 200. When the client apparatus 200 receives the HPD signal, the screen saver detects the reception as a connection event of an external device.

A user allows this display system to display an image produced from the client apparatus 200 on the display of the monitoring apparatus 100a. This display system is used, for example, at the time of performing a presentation.

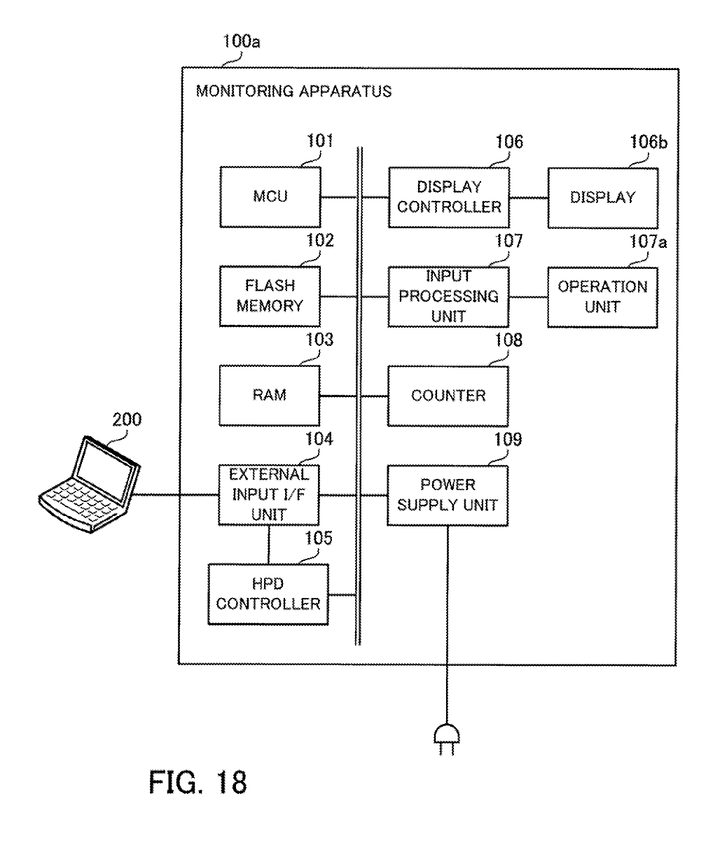

FIG. 18 illustrates a hardware example of the monitoring apparatus. The monitoring apparatus 100a includes the MCU 101, the flash memory 102, the RAM 103, the external input I/F unit 104, the HPD controller 105, the display controller 106, a display 106b, the input processing unit 107, the operation unit 107a, the counter 108, and the power supply unit 109.

Here, the hardware example of the monitoring apparatus 100a illustrated in FIG. 18 is compared with that of the projection apparatus 100 illustrated in FIG. 3. The monitoring apparatus 100a differs from the projection apparatus 100 in that the monitoring apparatus 100a includes the display 106b in place of the projection unit 106a. The display controller 106 controls display processing of the display 106b. Specifically, the display controller 106 allows the display 106b to display an image based on the image data supplied to the external input I/F unit 104.

Even the above-described monitoring apparatus 100a implements the same functions as those of the projection apparatus 100 according to the second embodiment. The functions are the same as those illustrated in FIGS. 6 to 15, and therefore their descriptions will not be repeated.

As a result, even the monitoring apparatus 100a acquires the same effect as that of the projection apparatus 100 according to the second embodiment.

The client apparatus 200 according to the second and third embodiments includes the screen saver function of switching the output image to the predetermined image at the time when an event is not detected only for the time Z. However, when an event is not detected only for the time Z, the client apparatus 200 may include an automatic output off function of stopping an image output in place of the screen saver function. Also in this case, the display system implements the automatic output off function, and avoids a situation that nothing is displayed on an image to be produced from the projection apparatus 100 or an image to be displayed by the monitoring apparatus 100a.

As can be seen from various embodiments discussed above, the proposed display system, display apparatus, and control method permit a screen to be easily suppressed from being changed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A display system comprising:
an information processing apparatus including:
an image output unit configured to output image data; and
an image output controller configured to control the image output unit so as to switch a display state of an image to a predetermined display state in the case where a connection signal is not received again for a predetermined time after detecting connection of another device by receiving the connection signal; and a display apparatus including:
an interface unit configured to receive image data produced from the image output unit of the information processing apparatus;
a display unit configured to display an image based on the image data received by the interface unit; and
a controller configured to receive a setting input of a period shorter than the predetermined time and allow the interface unit to repeatedly output the connection signal at the set period.

2. A display apparatus to be connected to an information processing apparatus which includes a function of switching a display state of an image to be output to a predetermined display state and display the image produced from the information processing apparatus in the case where a connection signal is not received again for a predetermined time after detecting connection of another device by receiving the connection signal, the display apparatus comprising:
an interface unit configured to receive image data produced from the information processing apparatus; and
a controller configured to receive a setting input of a period, and allow the interface unit to repeatedly output the connection signal at the set period.

3. The display apparatus according to claim 2, wherein while the image data received from the information processing apparatus fails to change, the controller allows the interface unit to perform an output of the connection signal at the period.

4. The display apparatus according to claim 3, further comprising:
a first memory unit configured to store past image data received from the information processing apparatus; and
a second memory unit configured to store newest image data to be received from the information processing apparatus,
wherein when the newest image data is stored in the second memory unit, the newest image data and the past image data stored in the first memory unit are compared with each other, and the controller detects the presence or absence of a change in the image data, and allows an image to be displayed based on the image data stored in the first memory unit until detecting that the image data changes after detecting that there is no change in the image data.

5. The display apparatus according to claim 4, wherein until a predetermined waiting time elapses after the interface unit outputs the connection signal to the information processing apparatus, the controller continues to allow an image to be displayed based on the image data stored in the first memory unit.

6. A control method for use in a display apparatus which is connected to an information processing apparatus which includes a function of switching a display state of an image to be output to a predetermined display state and displays the image produced from the information processing apparatus in the case where a connection signal is not received again only for a predetermined time after detecting connection of another device by receiving the connection signal, the control method comprising:
allowing an interface unit which receives image data produced from the information processing apparatus, included in the display apparatus to repeatedly output the connection signal to the information processing apparatus at a period set according to an input.

7. The control method according to claim 6, further comprising allowing the interface unit to perform an output of the connection signal at the period while the image data received from the information processing apparatus fails to change.

8. The control method according to claim 7, further comprising:
referring to a first memory unit to store past image data received from the information processing apparatus and a second memory unit to store newest image data to be received from the information processing apparatus;
comparing, when newest image data is stored in the second memory unit, the newest image data and the past image data stored in the first memory unit;
detecting the presence or absence of a change in the image data; and
allowing an image to be displayed based on the image data stored in the first memory unit until detecting that the image data changes after detecting that there is no change in the image data.

9. The control method according to claim 8, further comprising continuing to allow an image to be displayed based on the image data stored in the first memory unit until a predetermined waiting time elapses after the interface unit outputs the connection signal to the information processing apparatus.
